(19) United States
(12) Patent Application Publication
(10) Pub. No.: US 2012/0268802 A1
(43) Pub. Date: Oct. 25, 2012

(54) Laser Scanning Optical Device

(76) Inventors: Yasushi Nagasaka, Okaza-ki (JP); Naoki Tajima, Sagamihara-shi (JP); Takahiro Matsuo, Tokyo (JP)

(21) Appl. No.: 13/434,687

(22) Filed: Mar. 29, 2012

(30) Foreign Application Priority Data
Apr. 21, 2011 (JP) 2011-094579

(51) Int. Cl. G02B 26/10

(52) U.S. Cl. 359/210.2

(57) ABSTRACT

The laser scanning optical device comprises: a light source; a collimator lens; a light source holder; a lens holder; a light source unit holder; a first rotation axis; and a second rotation axis. The light source includes a plurality of light emitting points. The collimator lens converts diverging rays irradiated from the light source into parallel rays. The light source holder holds the light source. The lens holder holds the collimator lens. The light source unit holder holds the light source holder and the lens holder. The first rotation axis rotates the collimator lens with respect to an ideal optical axis. The second rotation axis rotates the light source unit holder while constantly maintaining a positional relationship between the light source holder and the lens holder.

### CROSS-REFERENCE TO RELATED APPLICATION

The present U.S. patent application claims a priority under the Paris Convention of Japanese patent application No. 2011-094579 filed on Apr. 21, 2011, which shall be a basis of correction of an incorrect translation, and is incorporated by reference herein.

### BACKGROUND OF THE INVENTION

1. Field of the Invention

The present invention relates to a laser scanning optical device.

2. Description of the Related Art

Heretofore, on an image forming apparatus such as a laser printer and a digital copier, a laser scanning optical device is mounted, which irradiates a laser beam onto a photosensitive body in order to expose the photosensitive body.

In the laser scanning optical device, there are provided: a light source that has a plurality of light emitting points which irradiate laser beams; a holder that holds the light source; a collimator lens that converts diverging rays, which are irradiated from the light source, into parallel rays; and the like. Then, there has been known a technique for adjusting a relative angle of the collimator lens with respect to the light source and thereby equalizing beam diameters of the laser beams on the photosensitivity body (for example, refer to Japanese Patent Laid-Open Publication No. 2006-194973).

Incidentally, in the conventional laser scanning optical device, when there is an arrangement error in the light source, it has been an actual situation that an optical axis of the collimator lens shifts from an ideal optical axis of the time of designing even if the relative angle of the collimator lens is adjusted in order to equalize the beam diameters at the respective laser beams on the photosensitive body. Then, it is necessary to upsize the collimator lens in order to suppress deterioration of optical characteristics of the collimator lens owing to such shift and other influences from the shift.

### SUMMARY OF THE INVENTION

The present invention has been made in consideration of the above-described problems inherent in the conventional technique. It is an object of the present invention to suppress the shift from the ideal optical axis, which occurs by adjusting the relative angle of the collimator lens, even if there is an arrangement error in the light source.

To achieve at least one of the abovementioned objects, a laser scanning optical device, reflecting one aspect of the present invention comprises:

a light source including a plurality of light emitting points;

a collimator lens which converts diverging rays irradiated from the light source into parallel rays;

a light source holder which holds the light source;

a lens holder which holds the collimator lens;

a light source unit holder which holds the light source holder and the lens holder;

a first rotation axis which rotates the collimator lens with respect to an ideal optical axis; and

a second rotation axis which rotates the light source unit holder while constantly maintaining a positional relationship between the light source holder and the lens holder.

Preferably, the first rotation axis and the second rotation axis are arranged on the same straight line.

Preferably, the first rotation axis and the second rotation axis are arranged in a vicinity of a principal point position of the collimator lens.

### BRIEF DESCRIPTION OF THE DRAWINGS

The present invention will be more fully understood by the following detailed description and the accompanying drawings. However, these are not intended to limit the present invention, wherein:

FIG. 1 is a schematic view showing a schematic configuration of a laser scanning optical device according to an embodiment of the present invention;

FIG. 2 is a perspective view showing a schematic configuration of a laser irradiation unit according to this embodiment;

FIG. 3 is a cross-sectional view of the laser irradiation unit of FIG. 2;

FIG. 4 is an explanatory view schematically showing respective optical systems in a main scanning direction in an ideal state according to this embodiment;

FIG. 5 is an explanatory view schematically showing the respective optical systems in the main scanning direction in a case where there is an arrangement error in a light source according to this embodiment;

FIG. 6 is an explanatory view schematically showing the respective optical systems in the main scanning direction in a case where, from a state of FIG. 5, a lens holder is rotated about a shaft body to thereby rotate only a first optical system (a collimator lens) with respect to an ideal optical axis;

FIG. 7 is a cross-sectional view showing a modification example of the laser irradiation unit according to this embodiment;

FIG. 8 is a perspective view showing a modification example of the laser irradiation unit according to this embodiment; and

FIG. 9 is a schematic view showing a modification example of the laser scanning optical device according to this embodiment.

### PREFERRED EMBODIMENTS OF THE PRESENT INVENTION

By using the drawings, a description is made below for preferred embodiments for carrying out the present invention. Note that, though a variety of limitations technically preferable for carrying out the present invention are imposed on embodiments which will be described below, the scope of the invention is not limited to the following embodiments and illustrated examples.

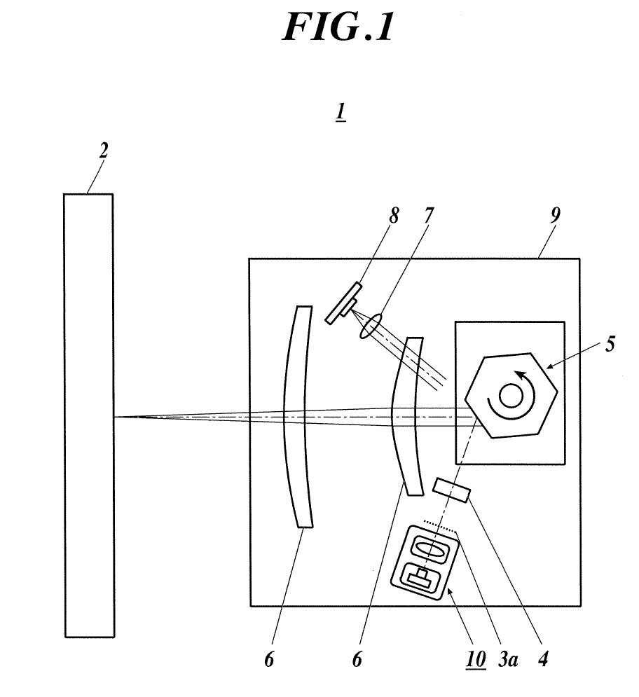

FIG. 1 is a schematic view showing a schematic configuration of a laser scanning optical device according to an embodiment of the present invention. As shown in FIG. 1, a laser scanning optical device 1 is a device that irradiates laser beams onto a photosensitive body 2 and exposes the photosensitive body 2 concerned. The laser scanning optical device 1 includes a laser irradiation unit 10 mounted thereon: a light source 100 that irradiates the laser beams; and a first optical system 3 that converts, into parallel rays, diverging rays irradiated from the light source 100. Moreover, the laser scanning optical device 1 includes: an optical slit 3a that regulates luminous flux widths of the parallel rays, which are converted by the first optical system 3, in main/sub-scanning directions; a second optical system 4 that converts such rays, which pass through the optical slit 3a, into converged light only in the sub-scanning direction; a polarizer 5 that polarizes the converged light converted by the second optical system 4; a third optical system 6 that condenses such polarized laser beams on the photosensitive body 2; and a fourth optical system 7 and a sensor 8, which are for adjusting timing of a writing start position. These constituents are held in an optical housing 9.

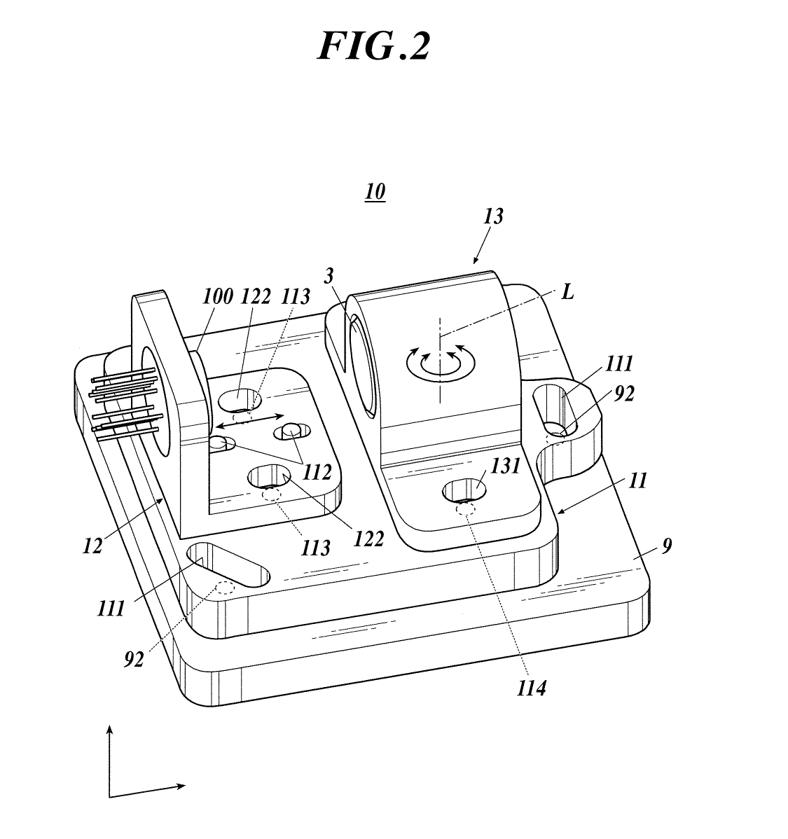

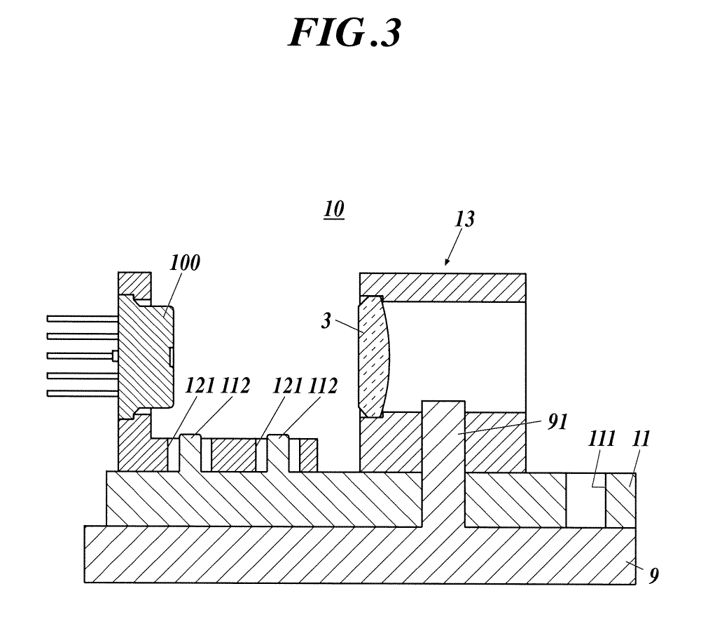

FIG. 2 is a perspective view showing a schematic configuration of the laser irradiation unit 10, and FIG. 3 is a cross-sectional view of the laser irradiation unit 10. As shown in FIG. 2 and FIG. 3, in the laser irradiation unit 10, a light source unit holder 11 supported by the optical housing 9 is provided. On an upper surface of the light source unit holder 11, there are mounted: a light source holder 12 that holds the light source 100; and a lens holder 13 that holds a collimator lens as the first optical system 3.

On an upper surface of the optical housing 9, a shaft body 91 erected in a direction perpendicular to the upper surface concerned protrudes. Moreover, in the upper surface of the optical housing 9, screw holes 92 are formed.

Moreover, the light source unit holder 11 is mounted on the upper surface of the optical housing 9 so as to allow penetration of the shaft body 91, which is performed therethrough. In such a way, the light source unit holder 11 rotates about the shaft body 91 on the optical housing 9. Moreover, in the light source unit holder 11, a plurality of long holes 111 are formed so as to face to the screw holes 92 of the optical housing 9. Screws (not shown) are screwed to the screw holes 92 through the long holes 111, whereby the light source unit holder 11 can be fixed onto the optical housing 9. A length of the long holes 111 is a rotatable range of the light source unit holder 11. Moreover, on the upper surface of the light source unit holder 11, projections 112 which engage with the light source holder 12 are formed. Furthermore, in the upper surface of the light source unit holder 11, there are formed: light source holder-use screw holes 113 for fixing the light source holder 12 to the light source unit holder 11; and lens holder-use screw holes 114 for fixing the lens holder 13 thereto.

The light source holder 12 holds the light source 100 so that the light source 100 can face to the first optical system 3 held in the lens holder 13 in the event of being arranged on the upper surface of the light source unit holder 11. In the light source holder 12, both of projection-use long holes 121 to engage with the projections 112 and light source-fixing long holes 122 arranged at positions facing to the light source holder-use screw holes 113 are formed so as to be parallel to each other. Screws (not shown) are screwed to the light source holder-use screw holes 113 through the light source-fixing long holes 122, whereby the light source holder 12 can be fixed onto the light source unit holder 11. A length of the light source-fixing long holes 122 is a movable range of the light source holder 12.

The lens holder 13 holds the first optical system 3 so that the first optical system 3 concerned can face to the light source 100. The shaft body 91 that protrudes from the light source unit holder 11 penetrates the lens holder 13. In such a way, the lens holder 13 will rotate about the shaft body 91 on the light source unit holder 11. Moreover, in the lens holder 13, lens-fixing long holes 131 arranged at positions facing to the lens holder-use screw holes 114 are formed. Screws (not shown) are screwed to the lens holder-use screw holes 114 through the lens-fixing long holes 131, whereby the lens holder 13 can be fixed onto the light source unit holder 11. A length of the lens-fixing long holes 131 is a rotatable range of the lens holder 13.

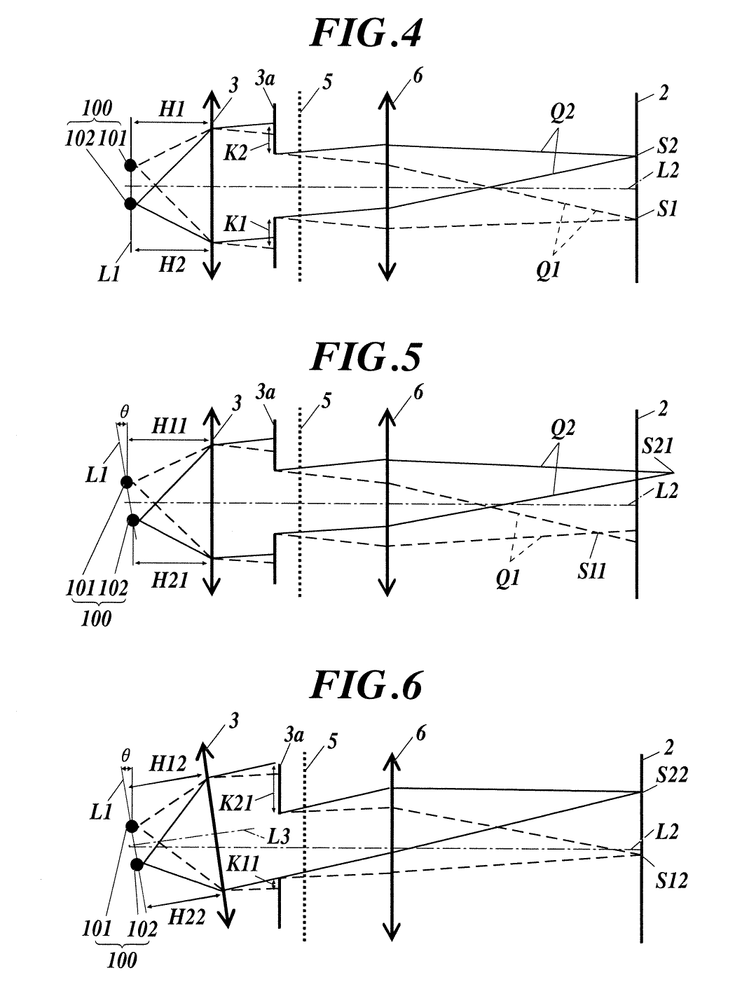

Here, when the lens holder 13 is rotated about the shaft body 91, the first optical system 3 will rotate with respect to an ideal optical axis L2 (refer to FIG. 4). Moreover, when the light source unit holder 11 is rotated about the shaft body 91, the light source holder 12 and the lens holder 13 will rotate while constantly maintaining a positional relationship between the light source holder 12 and the lens holder 13. That is to say, this shaft body 91 is a first rotation axis and a second rotation axis according to the present invention. Note that, in FIG. 2, an alternate long and short dash line L indicates the first rotation axis and the second rotation axis, which are composed of the shaft body 91.

Next, a description is made of functions of this embodiment.

First, FIG. 4 is an explanatory view schematically showing the respective optical systems in the main scanning direction in an ideal state according to this embodiment. FIG. 4 illustrates two light emitting points 101 and 102, which are located on both ends of the light source 100, among a plurality of light emitting points provided in the light source 100. Moreover, in FIG. 4, dotted lines Q1 are optical paths of a laser beam irradiated from the light emitting point 101 as one of the two light emitting points 101 and 102, and solid lines Q2 are optical paths of a laser beam irradiated from the light emitting point 102 as the other thereof. Moreover, a straight line L1 that connects centers of the two light emitting points 101 and 102 to each other is perpendicular to the ideal optical path L2, and respective distances H1 and H2 from the two light emitting points 101 and 102 to the first optical system 3 are the same. When the luminous flux widths are regulated by the slit 3a and the laser beams are condensed by the third optical system 6, then light condensing positions S1 and S2 of the laser beams irradiated individually by the two light emitting points 101 and 102 are located on the photosensitive body 2. A width K1 by which a luminous flux is shielded on a lower side of the slit 3a and a width K2 by which the luminous flux is shielded on an upper side thereof are the same.

FIG. 5 is an explanatory view schematically showing the respective optical systems in the main scanning direction in the case where there is an arrangement error in the light source 100. The straight line L1 that connects the centers of the two light emitting points 101 and 102 to each other shifts by an angle error θ with respect to the ideal optical axis L2, and respective distances H11 and H12 from the two light emitting points 101 and 102 to the first optical system 3 differ from each other. A light condensing position S11 of the laser beam irradiated from the light emitting point 101 as one of the pair shifts to a left side of the photosensitive body 2, and a light condensing position S21 of the laser beam irradiated from the light emitting point 102 as the other thereof shifts to a right side of the photosensitive body 2.

FIG. 6 is an explanatory view schematically showing the respective optical systems in the main scanning direction in the case where, from a state of FIG. 5, the lens holder 13 is rotated about the shaft body 90 to thereby rotate only the first optical system 3 with respect to the ideal optical axis L2. In this case, light condensing positions S12 and S22 of the laser beams irradiated individually from the two light emitting points 101 and 102 are returned onto the photosensitive body 2.

Moreover, respective distances H12 and H22 from the two light emitting points 101 and 102 to the first optical system 3 become the same, and an optical axis L3 of the first optical system 3 shifts from the ideal optical axis L2. In such a way, a width K11 by which the luminous flux is shielded on the lower side of the slit 3a and a width K21 by which the luminous flux is shielded on the upper side thereof differ from each other, and the upper side and the lower side become asymmetric to each other. Accordingly, it becomes necessary to suppress a possibility that optical characteristics may be deteriorated, and to increase an effective diameter of the first optical system 3.

However, the light source unit holder 11 is rotated about the shaft body 91, and the light source holder 12 and the lens holder 13 are thereby rotated while constantly maintaining the positional relationship between the light source holder 12 and the lens holder 13 so that the optical axis L3 of the first optical system 3 can overlap with the ideal optical axis L2, and then a relative angle of the first optical system 3 with respect to the light source 100 can be adjusted to the state shown in FIG. 4.

As described above, in accordance with this embodiment, there are provided: the first rotation axis for rotating the first optical system 3 with respect to the ideal optical axis L2; and the second rotation axis for rotating the light source unit holder 11 while constantly maintaining the positional relationship between the light source holder 12 and the lens holder 13. Accordingly, even if there is an arrangement error in the light source 100, the shift from the ideal optical axis L2, which occurs by adjusting the relative angle of the first optical system 3, can be suppressed.

Moreover, the first rotation axis and the second rotation axis are arranged on the same straight line on the shaft body 91, and accordingly, the light source unit holder 11 and the lens holder 13 can be rotated about the same rotation axis, and such a positional shift owing to a difference between optical axes can be suppressed.

Note that the present invention is appropriately changeable without being limited to the above-described embodiment. Note that, in the following description, the same reference numerals are assigned to the same portions as those of the first embodiment, and a description thereof is omitted.

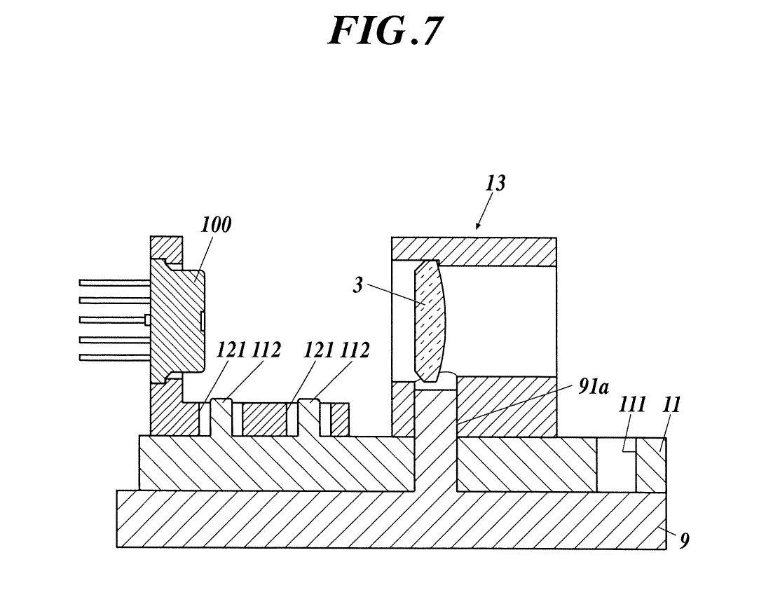

For example, in terms of suppressing an amount of the shift, it is preferable to arrange the shaft body 91a in the vicinity of a principal point position of the first optical system 3 as shown in FIG. 7.

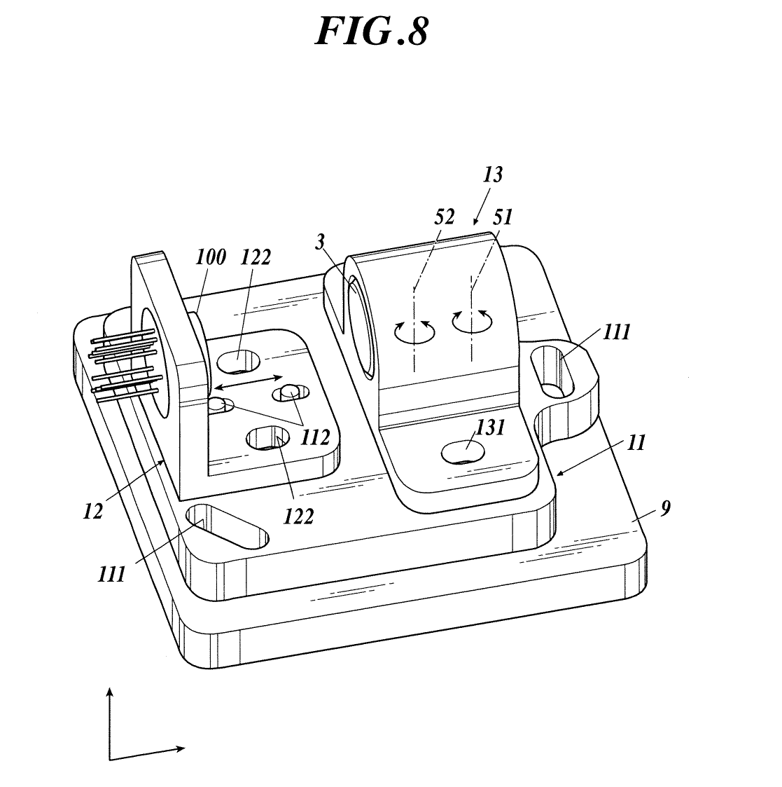

Moreover, though the case where the first rotation axis and the second rotation axis are arranged on the same straight line has been illustrated in the above-described embodiment, a first rotation axis 51 and a second rotation axis 52 may be arranged at positions different from each other as shown in FIG. 8.

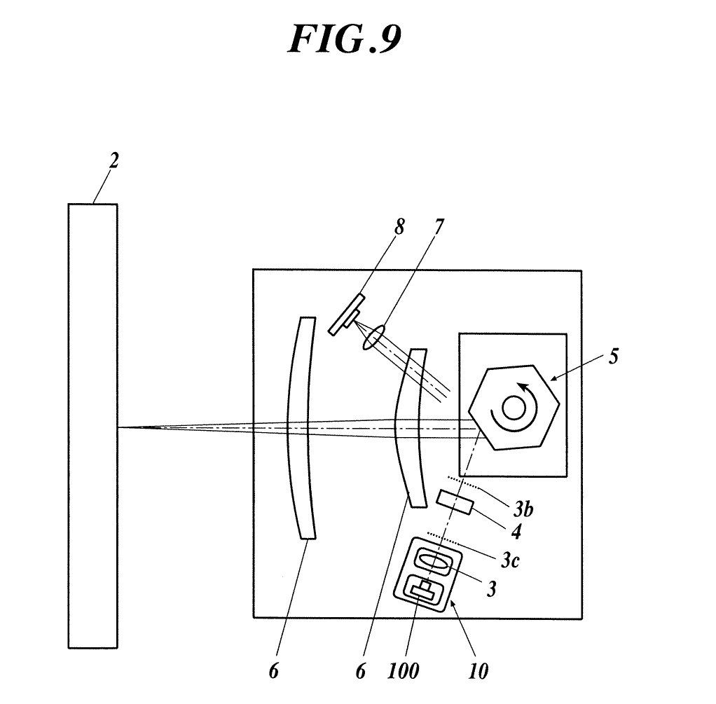

Further, though the case where the luminous flux widths in the main/sub-directions are regulated by the one slit 3a has been illustrated in the above-described embodiment, a first slit 3b that regulates the luminous flux width in the main scanning direction and a second slit 3c that regulates the luminous flux width in the sub-scanning direction may be individually provided as shown in FIG. 9. In this case, since a distance between the first slit 3b and the first optical system 3 becomes long, simple rotation of only the first optical system 3 increases asymmetry between the widths by which the luminous flux is shielded. However, the asymmetry is also suppressed if the optical axis L3 of the first optical system 3 and the ideal optical axis L2 are allowed to coincide with each other by rotating the light source unit holder 11 while constantly maintaining the positional relationship between the light source holder 12 and the lens holder 13.

According to preferred embodiments of the present invention, there is provided a laser scanning optical device comprising:

a light source including a plurality of light emitting points;

a collimator lens which converts diverging rays irradiated from the light source into parallel rays;

a light source holder which holds the light source;

a lens holder which holds the collimator lens;

a light source unit holder which holds the light source holder and the lens holder;

a first rotation axis which rotates the collimator lens with respect to an ideal optical axis; and

a second rotation axis which rotates the light source unit holder while constantly maintaining a positional relationship between the light source holder and the lens holder.

Preferably, the first rotation axis and the second rotation axis are arranged on the same straight line.

Preferably, the first rotation axis and the second rotation axis are arranged in a vicinity of a principal point position of the collimator lens.

What is claimed is:

1. A laser scanning optical device comprising:
a light source including a plurality of light emitting points;
a collimator lens which converts diverging rays irradiated from the light source into parallel rays;
a light source holder which holds the light source;
a lens holder which holds the collimator lens;
a light source unit holder which holds the light source holder and the lens holder;
a first rotation axis which rotates the collimator lens with respect to an ideal optical axis; and
a second rotation axis which rotates the light source unit holder while constantly maintaining a positional relationship between the light source holder and the lens holder.

2. The laser scanning optical device according to claim 1,
wherein the first rotation axis and the second rotation axis are arranged on the same straight line.

3. The laser scanning optical device according to claim 2,
wherein the first rotation axis and the second rotation axis are arranged in a vicinity of a principal point position of the collimator lens.
